(19) United States
(12) Patent Application Publication
(10) Pub. No.: US 2024/0046076 A1
(43) Pub. Date: Feb. 8, 2024

(54) DEVICE AND METHOD FOR PROCESSING A CONVOLUTIONAL NEURAL NETWORK WITH BINARY WEIGHTS

(71) Applicant: HUAWEI TECHNOLOGIES CO., LTD., Shenzhen (CN)

(72) Inventor: Van Minh NGUYEN, Boulogne Billancourt (FR)

(21) Appl. No.: 18/489,210

(22) Filed: Oct. 18, 2023

Related U.S. Application Data
(63) Continuation of application No. PCT/EP2021/060128, filed on Apr. 19, 2021.

(51) Int. Cl. G06N 3/0464

(52) U.S. Cl. CPC G06N 3/0464

(57) ABSTRACT

Various embodiments relate to convolutional neural networks (CNN). CNN may be provided with a convolution kernel configured with binary weights. The CNN may be trained with the convolution kernel to determine a set of binary weights for the convolution kernel. The set of binary weights may be used for inference of the CNN. Devices, methods, and computer programs are disclosed.

### CROSS-REFERENCE TO RELATED APPLICATIONS

This application is a continuation of International Application No. PCT/EP2021/060128, filed on Apr. 19, 2021, the disclosure of which is hereby incorporated by reference in its entirety.

### TECHNICAL FIELD

The present disclosure generally relates to artificial intelligence, machine learning, and neural networks. In particular, some embodiments of the disclosure relate to implementation and training of neural networks.

### BACKGROUND

Convolutional neural networks (CNN) are principal deep learning computing systems which have been the backbone of recent impressive successes in the field of computer vision, image recognition, and the like. CNNs are a particular architecture of a more general concept called Deep Neural Networks (DNN). DNNs are computing systems vaguely inspired by the biological neural networks that constitute biological brains. Deep neural networks may be trained to perform tasks by considering examples, generally without being programmed with any task specific rules. For example, in image recognition, they may be trained to identify images that contain cars by analyzing example images that have been manually labeled as including or not including cars and using the results to identify cars in other images. Deep neural networks are able to do this without any prior knowledge about cars. Instead, they automatically learn to identify characteristic features from training data. Training of deep neural networks, or machine learning models in general, may be a resource intensive process. Furthermore, complexity of a trained machine learning model may be too high for some devices.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective of the present disclosure to provide neural networks that have low complexity. Furthermore, efficient methods for training neural networks are disclosed. The foregoing and other objectives may be achieved by the features of the independent claims. Further implementation forms are apparent from the dependent claims, the description, and the figures.

In the following the expression “binary” or any derivatives thereof may refer to being in a state of one of two mutually exclusive conditions. In some embodiments, binary may be Boolean. In some embodiments, binary may be represented by a true/false value corresponding to a state of one of the two mutually exclusive conditions. In some embodiments, binary may be represented by a numerical value corresponding to a state of one of the two mutually exclusive conditions. The numerical value may be, for example, 0 and 1 for the two mutually exclusive conditions or −1 and 1 for the two mutually exclusive conditions.

According to a first aspect, a device is provided for processing a convolutional neural network (CNN). The device may be configured to provide the CNN, which has a convolution kernel configured with binary weights. The device may be further configured to train the CNN with the convolution kernel to determine a set of binary weights for the convolution kernel. The device may also be configured to use the set of binary weights for inference of the CNN. This solution enables a binary implementation of the CNN neural network with low complexity.

According to an implementation form of the first aspect, the device is configured to train the CNN by receiving, at a neuron of the CNN, a backpropagation signal from at least one neuron of a downstream layer of the CNN, wherein the backpropagation signal may indicate a tendency of a loss function with respect to a variation of an output of the neuron, evaluating, at the neuron, a pre-activation function, wherein an input of the pre-activation function comprises an ith binary weight of the neuron and a respective input of the neuron associated with the ith binary weight, determining a tendency of the pre-activation function with respect to inversion of the ith binary weight, and determining whether to invert the ith binary weight based on the tendency of the pre-activation function with respect to the inversion of the ith binary weight and the tendency of the loss function with respect to the variation of the output of the neuron. This solution enables backpropagation for training the CNN using binary weights with reduced complexity.

According to an implementation form of the first aspect, the tendency of the loss function with respect to the variation of the output of the neuron may indicate whether the variation of the output of the neuron causes the loss function to increase or decrease. The tendency of the pre-activation function with respect to the inversion of the ith binary weight may indicate whether the inversion of the ith binary weight causes the pre-activation function to increase or decrease. This solution enables determination of the tendency of the loss function and the tendency of the pre-activation function to train the CNN using binary weights with reduced complexity.

According to an implementation form of the first aspect, the device may be further configured to determine to invert the ith binary weight, in response to determining that the inversion of the ith binary weight causes the loss function to decrease. The device may be further configured to determine not to invert the ith binary weight, in response to determining that the inversion of the ith binary weight causes the loss function to increase. This solution enables to determine in the binary domain whether to invert a particular binary weight to efficiently train the CNN using binary weights.

According to an implementation form of the first aspect, the device may be further configured to determine that the inversion of the ith binary weight causes the loss function to increase if the activation function increases with respect to inversion of the ith binary weight and the loss function increases with respect to the output of the neuron. The device may further be configured to determine that the inversion of the ith binary weight causes the loss function to decrease if the activation function increases with respect to inversion of the ith binary weight and the loss function decreases with respect to the output of the neuron. The device may further be configured to determine that the inversion of the ith binary weight causes the loss function to decrease if the activation function decreases with respect to inversion of the ith binary weight and the loss function increases with respect to the output of the neuron. The device may further be configured to determine that the inversion of the ith binary weight causes the loss function to increase if the activation function decreases with respect to inversion of the ith binary weight and the loss function decreases with respect to the output of the neuron. This solution enables to determine how inversion of the ith binary weight affects the loss function, in order to train the CNN using binary weights with reduced complexity.

According to an implementation form of the first aspect, the device may be further configured to determine an ith upstream backpropagation signal for at least one upstream neuron of the CNN based on a tendency of the loss function with respect to a variation of an ith input of the neuron. This solution enables to determine a backpropagation signal in the binary domain to reduce complexity of training the CNN using binary weights.

According to an implementation form of the first aspect, the device may be further configured to use binary input values as inputs of neurons of the CNN. This solution enables a binary implementation of the CNN neural network with reduced complexity.

According to an implementation form of the first aspect, a convolution operator of the convolution kernel is a binary-valued operator. This solution enables a binary implementation of the CNN neural network with reduced complexity.

According to an implementation form of the first aspect, the device may be further configured to determine a pre-activation value for a neuron of the CNN using a convolution for the CNN based on the convolution kernel. The device may be further configured to determine an output of the neuron from the pre-activation value as a binary output based on a threshold value. This solution enables a binary implementation of the CNN neural network with reduced complexity.

According to an implementation form of the first aspect, the threshold value is a parameter to be learnt for the training of the CNN. This solution enables to improve training of the CNN by using the threshold value as an additional trainable parameter of the CNN or the neuron thereof.

According to an implementation form of the first aspect, the device may comprise a plurality of configurable base logics. Each may comprise a feeding receptor for providing an input of the neuron, a configurable bit for implementing the respective binary weight, and a convolution operator coupled to the feeding receptor and the configurable bit for performing a convolution operation with respect to the input and the respective binary weight. This solution provides an efficient hardware implementation for the convolution kernel.

According to an implementation form of the first aspect, the device may comprise a memory for storing pre-activation values for neurons of the CNN. This solution provides an efficient hardware implementation for training the CNN using binary weights with reduced complexity.

According to a second aspect, a method is provided for processing a convolutional neural network (CNN). The method may comprise configuring the CNN for utilizing a convolution kernel with binary weights. The method may comprise training the CNN with the convolution kernel to determine a set of binary weights for the convolution kernel. The method may comprise using the set of binary weights for inference of the CNN. This solution enables a binary implementation of the CNN neural network with low complexity.

According to an implementation form of the second aspect, the training of the CNN may comprise receiving, at a neuron of the CNN, a backpropagation signal from at least one neuron of a downstream layer of the CNN, wherein the backpropagation signal indicates a tendency of a loss function with respect to a variation of an output of the neuron. The training may comprise evaluating, at the neuron, a pre-activation function, wherein an input of the pre-activation function comprises an ith binary weight of the neuron and a respective input of the neuron associated with the ith binary weight. The training may comprise determining a tendency of the pre-activation function with respect to inversion of the ith binary weight. The training may comprise determining whether to invert the ith binary weight based on the tendency of the pre-activation function with respect to the inversion of the ith binary weight and the tendency of the loss function with respect to the variation of the output of the neuron. This solution enables backpropagation for training the CNN using binary weights with reduced complexity.

According to an implementation form of the second aspect, the tendency of the loss function with respect to the variation of the output of the neuron may indicate whether the variation of the output of the neuron causes the loss function to increase or decrease. The tendency of the pre-activation function with respect to the inversion of the ith binary weight may indicate whether the inversion of the ith binary weight causes the pre-activation function to increase or decrease. This solution enables determination of the tendency of the loss function and the tendency of the pre-activation function to train the CNN using binary weights with reduced complexity.

According to an implementation form of the second aspect, the method may further comprise determining to invert the ith binary weight, in response to determining that the inversion of the ith binary weight causes the loss function to decrease. The method may further comprise determining not to invert the ith binary weight, in response to determining that the inversion of the ith binary weight causes the loss function to increase. This solution enables to determine in the binary domain whether to invert a particular binary weight to efficiently train the CNN using binary weights.

According to an implementation form of the second aspect, the method may further comprise determining that the inversion of the ith binary weight causes the loss function to increase if the activation function increases with respect to inversion of the ith binary weight and the loss function increases with respect to the output of the neuron. The method may further comprise determining that the inversion of the ith binary weight causes the loss function to decrease if the activation function increases with respect to inversion of the ith binary weight and the loss function decreases with respect to the output of the neuron. The method may further comprise determining that the inversion of the ith binary weight causes the loss function to decrease if the activation function decreases with respect to inversion of the ith binary weight and the loss function increases with respect to the output of the neuron. The method may further comprise determining that the inversion of the ith binary weight causes the loss function to increase if the activation function decreases with respect to inversion of the ith binary weight and the loss function decreases with respect to the output of the neuron. This solution enables to determine how inversion of the ith binary weight affects the loss function, in order to train the CNN using binary weights with reduced complexity.

According to an implementation form of the second aspect, the method may further comprise determining an ith upstream backpropagation signal for at least one upstream neuron of the CNN based on a tendency of the loss function with respect to a variation of an ith input of the neuron. This solution enables to determine a backpropagation signal in the binary domain to reduce complexity of training the CNN using binary weights.

According to an implementation form of the second aspect, binary input values may be used as inputs of neurons of the CNN. This solution enables a binary implementation of the CNN neural network with reduced complexity.

According to an implementation form of the second aspect, a convolution operator of the convolution kernel may be a binary-valued operator. This solution enables a binary implementation of the CNN neural network with reduced complexity.

According to an implementation form of the second aspect, the method may further comprise determining a pre-activation value for a neuron of the CNN using a convolution for the CNN based on the convolution kernel. The method may further comprise determining an output of the neuron from the pre-activation value as a binary output based on a threshold value. This solution enables a binary implementation of the CNN neural network with reduced complexity.

According to an implementation form of the second aspect, the threshold value may be a parameter to be learnt for the training of the CNN. This solution enables to improve training of the CNN by using the threshold value as an additional trainable parameter of the CNN or the neuron thereof.

According to an implementation form of the second aspect, the convolution kernel may be provided utilizing a plurality of configurable base logics. Each may comprise a feeding receptor for providing an input of the neuron, a configurable bit for implementing the respective binary weight, and a convolution operator coupled to the feeding receptor and the configurable bit for performing a convolution operation with respect to the input and the respective binary weight. This solution provides an efficient hardware implementation for the convolution kernel.

According to an implementation form of the second aspect, the method may comprise storing pre-activation values for neurons of the CNN into memory. The memory may be non-transient. This solution provides an efficient hardware implementation for training the CNN using binary weights with reduced complexity.

According to a third aspect, a computer program is provided for processing a CNN. The computer program may comprise program code configured to cause performance of any implementation form of the second aspect, when the computer program is executed on a computer. The computer program may be configured for training the CNN.

Implementation forms of the disclosure can thus provide a device, a method, a computer program for processing and training neural networks with low complexity. These and other aspects of the disclosure will be apparent from the example embodiment(s) described below.

Any of the aspects may be used to enable CNN natively embedded in an edge device for edge computing, i.e. providing CNN directly trained on the device. Edge computing, which may also be referred as artificial intelligence (AI) on the edge, necessitates computationally light CNNs because edge devices may be relatively much less powerful than dedicated counterparts. They may also have limited storage resources and/or stored resources.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of training and inference of a machine learning model according to an embodiment of the present disclosure;

FIGS. 2a and 2b illustrate examples of a standard approach of training and inference of a machine learning model and an improved approach of training and inference of a machine learning model according to an embodiment of the present disclosure, respectively;

FIG. 3 illustrates an example of a device configured to practice one or more embodiments of the present disclosure;

FIG. 4 schematically illustrates an example of training a machine learning model in accordance with a first approach (upper path) and in accordance with a second, improved approach (lower path) according to an embodiment of the present disclosure;

FIG. 5 illustrates an example of a variational backpropagation method according to an embodiment of the present disclosure;

FIG. 6 illustrates an example of a hardware implementation of a binary convolution kernel according to an embodiment of the present disclosure;

FIGS. 7a and 7b illustrate examples of a topology for configuring a full-precision CNN and a topology for binary configuration of a CNN according to an embodiment of the present disclosure, respectively;

FIGS. 8a and 8b illustrate examples of tested performance of a full-precision CNN and a CNN with binary weights according to an embodiment of the present disclosure, respectively; and

FIG. 9 illustrates an example of a method for processing a CNN according to an embodiment of the present disclosure.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present embodiments and is not intended to represent the only forms in which the present examples may be constructed or utilized. The description sets forth the functions of the examples and the sequence of operations for constructing and operating the examples. However, the same or equivalent functions and sequences may be accomplished by different examples.

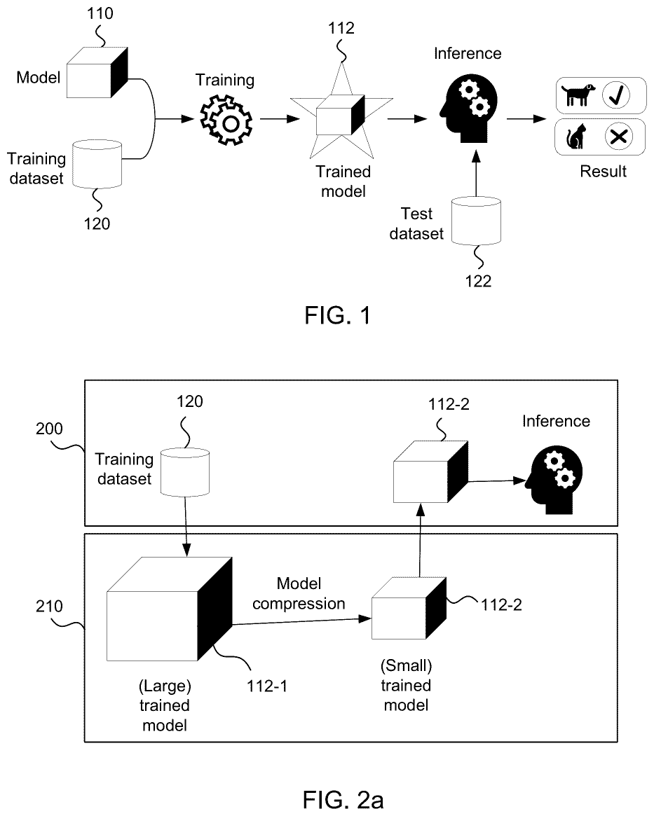

FIG. 1 illustrates an example of training and inference of a machine learning model according to an embodiment of the present disclosure. A machine learning model 110, represented by a convolutional neural network (CNN) in this example, may be based on a collection of connected units or nodes called artificial neurons, which loosely model the neurons in a biological brain. Each connection, like the synapses in a biological brain, can transmit a signal from one artificial neuron to another. An artificial neuron that receives a signal can process it and then activate additional artificial neurons connected to it. Artificial neurons may be aggregated into layers, where different layers may perform different kinds of transformations on their inputs. The connections between the artificial neurons may be associated with weights that are adjusted during training of the CNN. The weight increases or decreases the strength of the signal at a connection. The CNN as disclosed herein may have multiple layers.

In common CNN design, the signal at a connection between artificial neurons is a real number, and the output of each artificial neuron is computed by some non-linear function of the sum of its inputs. The connections between artificial neurons typically have a weight that adjusts as learning proceeds. The weight increases or decreases the strength of the signal at a connection. Artificial neurons may have a threshold such that the signal is only sent if the aggregate signal crosses that threshold.

A general scheme of training and inference process of a CNN is illustrated in FIG. 1. Therein, the model 110 may comprise, for example, a convolutional neural network with a given architecture. The process may be split into two phases. In a training phase, the model 110 may be trained with a given training dataset 120 to adjust its weights, or in general any learnable parameters of the model 110. Then, in an inference phase, the trained model 112 may be used to perform predictions on unseen data of a test dataset 122. An output, or a result, of the trained model 112 may, for example, comprise classification of an image of the test dataset 122 into the classes of dogs or cats.

CNNs, including the one disclosed herein, may be used for many applications, for example in connection with modern communication networks. CNNs may therefore play a very important role in devices in future networks, such as smartphones, sensors, and/or wearables. Also other devices where energy saving is pursued, such as datacenter devices, may be included. For example, CNNs may be applied in smartphones for various applications, including image recognition, portrait mode photography, text prediction, user profiling, image filters, de-noising, and camera enhancement. A motivation is thus to have CNNs natively embedded in edge devices, i.e. neural network is directly trained on the device. as AI on the edge is becoming a major industrial trend. AI on the edge necessitates computationally light CNNs because edge devices are relatively much less powerful than dedicated counterparts. The may also have limited storage and/or stored resources, as well as energy peak issues.

A Binary Neural Network (BNN) may be formed as a CNN. By concept, all weights and activations in a BNN may be represented by binary numbers which use 1 bit instead of 32 bits used by a full-precision CNN. This may significantly reduce the memory footprint.

Training a neural network with low-precision weights (even a single-layer one) is an NP-hard optimization problem. For example, due to weight discretization, the backpropagation algorithms for continuous CNNs, which may be based on computing the gradient of the loss function, may not be effective. The problem of unstable gradients may appear as soon as the number of bits for representing numbers is less than eight.

Thus, efficient training of low-precision neural networks (NNs) may be based on the use of gradient approximations, which may require storing a floating point weight along with the low precision weight and performing some form of backpropagation with floating point arithmetic (thus relinquishing some of the discretization advantage). In order to address this issue, a full precision value may be kept for each weight and then (i) this value may be binarized and (ii) the full precision value may be updated by a straight-through estimator for the gradient evaluated on the binarized value.

However, it is noted that it may be considered a limitation if the design strictly relies on the full-precision network with gradient descent backpropagation for the network training. As a result, although the obtained BNN can reduce memory usage in the prediction phase, it needs full-precision network training hence may not solve the blocking memory problem of network training.

Another approach to train BNNs is to use algorithms inspired by statistical physics. The limitation is that such algorithms are typically designed for specific types of networks and may not be applicable in a straightforward manner to CNN and deep architectures. They may also not necessarily be usable for NNs with multiple layers.

An alternative approach to overcome the lack of gradient information is to address training as a combinatorial optimization problem and apply a known method for this type of problems. An approach is to use evolutionary algorithms, which however may suffer from performance and scalability issues. First, although only low-precision weights may be considered, the number of weights stored in memory may be multiplied by the population size, and therefore, even for binary weights and a modest population size of 100, the memory footprint may be larger than storing decimal weights with 16, 32 or 64 bits floating point representation. Second, a single forward pass during training may need to be performed for all members of the population. Even though this may be done in parallel, having as many parallel processors as the population size may be prohibitive for training on a mobile device. Finally, the population size should increase with the number of weights (dimension of the optimization parameter space), making scaling for big neural networks problematic.

Thus, other solutions may be sought for training a low-precision CNN purely on a smartphone. It is for example possible to perform the computationally demanding training phase by using floating point arithmetic on the cloud, where the resource limitations are relaxed. Then, a low-precision version of the CNN may be provided on the smartphone to perform the less demanding inference (feed-forward) phase on unseen data. However, such an approach may produce only a fixed pre-trained low-precision CNN, which may not be desired. Low-precision neural networks may be implemented in software or hardware. Binary neural networks in particular, may be implemented efficiently based on bitwise operations (in software) or digital logic circuits such as NOR or XNOR (in hardware).

Embodiments of the present disclosure may be applied to greatly reduce the resource demand of machine learning models such that they can be directly implemented and/or trained on resource constrained devices. On the one hand, an example of a hardware circuit (BOOLNET) for building purely binary neurons is disclosed. Furthermore, a method for training such neural network without the need of full-precision arithmetic is disclosed. One field of applications of the disclosed neural networks is the AI on the edge (also “Edge AI”), which may be implemented near the radio interface in a communication network. Edge AI benefits from use of neural networks having low memory and computation requirements for example because that enables neural networks to be directly trained on an edge device. The disclosed neural networks may be applied for example in computer vision, image recognition, object detection, autonomous cars, or as native AI for sixth generation (6G) communication systems.

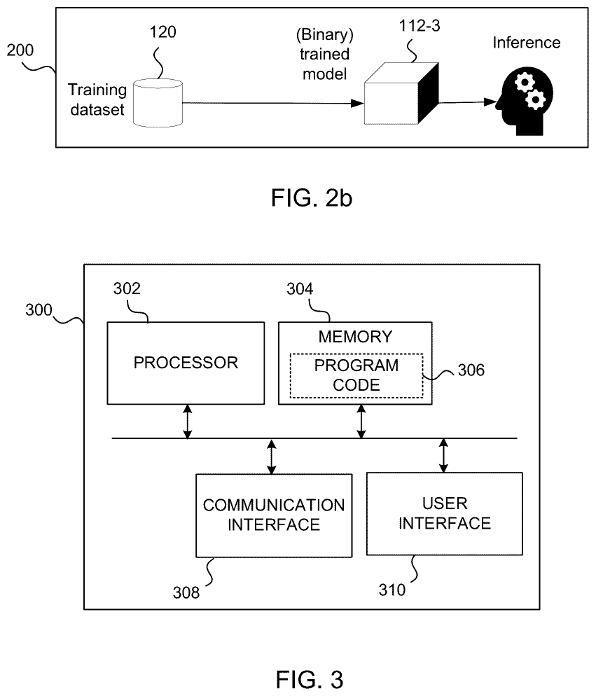

FIGS. 2a and 2b illustrate examples of a standard approach of training and inference of a machine learning model and an improved approach of training and inference of a machine learning model according to an embodiment of the present disclosure, respectively. In both cases, the general scheme for training and inference of a CNN, for example as presented above in the context of FIG. 1, may be applied (some parts not illustrated in FIGS. 2a and 2b).

A typical CNN design requires tremendous computational power, energy, memory, data, both for training and testing. In a typical CNN design, all inputs, outputs, weights, biases, and activation functions are considered to be real numbers; each is typically represented in computers by a 32-bit sequence and is operated with real-valued arithmetic. It is noteworthy that in deep learning computer vision applications, we may have CNNs with thousands of neurons, where each neuron may have numerous inputs, resulting in millions of such 32-bit sequences. As a consequence, mobile applications are currently deployed in a decentralized setting: a CNN is trained on an external dedicated infrastructure, and then the trained network is shared with a mobile device. This strategy can be unsuitable for AI on the edge.

In an example of the standard approach, as illustrated in FIG. 2a, the training is performed remotely, for example, in a computing system 210 such as a cloud computing system. There, the trained model 112 may be first formed as a first trained model 112-1 and then subsequently compressed into a second trained 112-2, wherein the first trained model 112-1 is larger in terms of resource consumption such as memory usage in comparison to the second trained model 112-2. In this way, while the first trained model 112-1 may be unsuitable for AI on the edge, the second trained model 112-2 may be suitable for this purpose. The second trained model 112-2 may be transmitted to a remote device 200, such as an edge device for edge computing, where it may be used for inference. The remote device 200 may also be configured to provide the training dataset 120 for the computing system 210 for training the model.

In contrast, FIG. 2b illustrates an example of an improved approach of training and inference of a machine learning model according to an embodiment of the present disclosure, where the training is performed in the remote device 200. The remote device 200 may be configured to provide the training dataset 120 so that training the model can be performed within the remote device 200. A single trained model 112-3, which can be a binary model, may then be provided that is suitable for AI on the edge. This model can both be both trained and used for inference at the remote device so that the computing system 210 is not necessary for providing the model.

FIG. 3 illustrates an example of a device configured to practice one or more embodiments of the present disclosure. The device 300 may be the remote device 200 as described above. The device 300 may be configured to process a convolutional neural network (CNN), for example to provide and/or train the CNN. The device 300 may comprise at least one processor 302. The at least one processor 302 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The device 300 may further comprise at least one memory 304. The memory 304 may be configured to store, for example, computer program code or the like, for example operating system software and application software. The memory 304 may be also configured to store neural network(s). The memory 304 may comprise one or more volatile memory devices, one or more non-volatile memory devices, and/or a combination thereof. For example, the memory 304 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The device 300 may further comprise a communication interface 308 configured to enable the device 300 to transmit and/or receive information. The communication interface 308 may be configured to provide at least one wireless radio connection, such as for example a 3GPP mobile broadband connection (e.g. 3G, 4G, 5G); a wireless local area network (WLAN) connection such as for example standardized by IEEE 802.11 series or Wi-Fi alliance; a short range wireless network connection such as for example a Bluetooth, NFC (near-field communication), or RFID connection; a local wired connection such as for example a local area network (LAN) connection or a universal serial bus (USB) connection, or the like; or a wired Internet connection.

The device 300 may further comprise a user interface 310 comprising at least one input device and/or at least one output device. The input device may take various forms such a keyboard, a touch screen, or one or more embedded control buttons. The output device may for example comprise a display, a speaker, a vibration motor, or the like.

When the device 300 is configured to implement some functionality, some component and/or components of the device, such as for example the at least one processor and/or the memory, may be configured to implement this functionality. Furthermore, when the at least one processor is configured to implement some functionality, this functionality may be implemented using program code 306 comprised, for example, in the memory 304.

The functionality described herein may be performed, at least in part, by one or more computer program product components such as software components. According to an embodiment, the device comprises a processor or processor circuitry, such as for example a microcontroller, configured by the program code when executed to execute the embodiments of the operations and functionality described herein. Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

The device 300 may comprise means or is configured for performing method(s) described herein. In one example, the means comprises the at least one processor, the at least one memory including program code configured to, when executed by the at least one processor, cause the device to perform the method.

The device 300 may comprise, for example, a computing device such as for example a mobile phone, a tablet computer, a laptop, an internet of things (IoT) device, a server or the like. Examples of IoT devices include, but are not limited to, consumer electronics, wearables, sensors, and smart home appliances. Although the device 300 is illustrated as a single device it is appreciated that, wherever applicable, functions of the device 300 may be distributed to a plurality of devices, for example, to implement example embodiments as a cloud computing service.

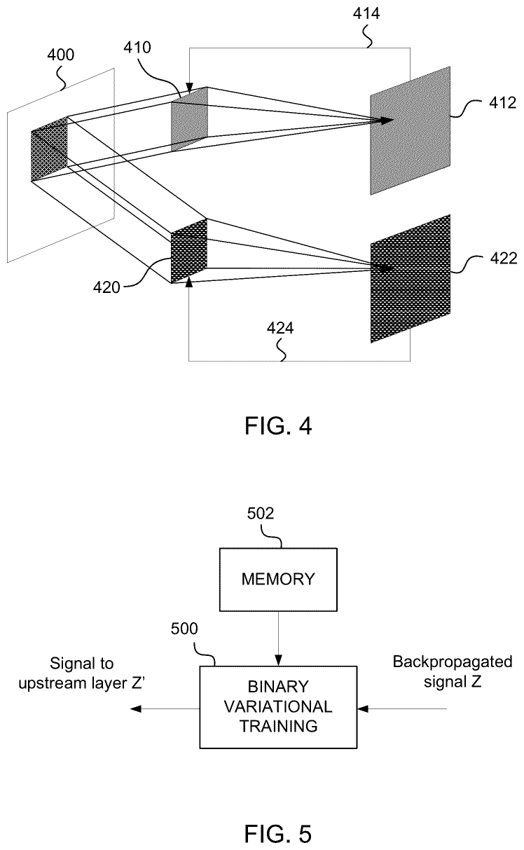

FIG. 4 schematically illustrates an example of training a machine learning model in accordance with a first approach (upper path) and in accordance with a second, improved approach (lower path) according to an embodiment of the present disclosure. Input feature map is provided as an upstream data set 400. The training of the CNN may comprise iterative loops of feed-forward and backpropagation passes (also simply “feed-forward” and “backpropagation”).

In the first approach, a first convolution kernel 410 is utilized for the CNN during feed-forward of the CNN from the input feature map may be a binary kernel. Real arithmetic may be used during feed-forward for arriving at a downstream data set 412, which may be a binary feature map. For backpropagation 414, a full-precision gradient map may be used as the downstream data set 412. Correspondingly, full-precision gradient descent backpropagation may be used for the backpropagation 414. During the backpropagation 414, a second convolution kernel 410 may be utilized with the second convolution kernel being a full-precision kernel.

The second approach may be utilized for providing one or more benefits of the present disclosure, including enabling a binary implementation of the CNN neural network with low complexity. Here, a convolution kernel 420 utilized for the CNN during feed-forward of the CNN from the upstream data set 400 may be the same convolution kernel 420 as utilized during backpropagation 424 of the CNN. The convolution kernel is a binary kernel and binary logics may be utilized during feed-forward for arriving at the downstream data set 422, which may be a binary feature map. For the backpropagation 424, binary variational backpropagation (also indicated here as binary variational training) may be used, which may include binary variational signal as the downstream data set 422. This approach may allow a notable reduction in memory required in comparison to the first approach.

In accordance with the present disclosure, a binary CNN utilizing 1-bit information may be provided. For this purpose, binary convolution kernel(s) and binary logics may be utilized. The CNN may be configured to be trained directly in binary domain. According to an embodiment, a CNN is provided. Neurons of the CNN may be configured with binary weights. The CNN may thus have a convolution kernel configured with binary weights. The binary weights may further be associated with respective binary inputs. The CNN with the convolution kernel may be trained to determine a set of binary weights for the convolution kernel. The set of binary weights may be used for inference of the CNN. Processing the CNN may comprise configuring the CNN for utilizing a convolution kernel with binary weights.

According to an embodiment, the convolution kernel (also called convolution filter or, here, simply kernel) may be a 3D tensor W of dimensions (h_{w}, w_{w}, c_{w}) for kernel height, width, and depth. A single version of the kernel W, a binary W, may be used for both inference and training of the CNN. Correspondingly, this single version of the kernel may be used for both feed-forward and backpropagation. All the elements of W may be binary elements such as Boolean elements or binary numbers. Each element of W may thus be encoded by only one bit, which may indicate True or False (or a binary value such as +/−1, or 0/1). This binary kernel W is directly trained during the training phase (also simply “training”) of the CNN and is used for the inference phase of the CNN (also simply “inference”). This is in contrast to having two versions of kernel W during the training phase, where the first one is a full-precision kernel W_{full} that is trained with a full-precision gradient descent method and the second one is a binary W_{bin} which is obtained from W_{full} and which is later used for the inference phase. In such an approach, also illustrated above as “the first approach”, W_{bin} can be computed from W_{full} subject to a predefined approximation target.

According to an embodiment, the convolution kernel comprises a convolution operator, which may be defined with binary logic. The convolution operator may be defined using binary logics such as XOR, AND OR, alone or in any combination. Alternatively or additionally, negative binary logics such as NOR, NAND and XNOR may be used, alone or in any combination. In particular, XOR or XNOR logic has been found efficient due to its symmetry and unexpected compatibility with the numerical implementation. The binary convolution operator may be used instead of a typically used real arithmetic operator. As an example, if X is a portion of data subjected to convolution with kernel W, X may have the same dimensions as W. Now, y may indicate the result of a convolution of X and W. In a standard convolution, y may be given as follows (Eq. 1):

y=Σᵢ₌₀^{h}^{_{w}}⁻¹Σⱼ₌₀^{w}^{_{w}}⁻¹Σₖ₌₀^{c}^{_{w}}⁻¹X[i,j,k]W[i,j,k],

which involves the standard multiplication and addition (summation).

In accordance with the invention, X and W may be binary, and y as their convolution may be given as follows (Eq. 2):

y=Σᵢ₌₀^{h}^{_{w}}⁻¹Σⱼ₌₀^{w}^{_{w}}⁻¹Σₖ₌₀^{c}^{_{w}}⁻¹BLO(X[i,j,k],W[i,j,k]),

wherein BLO is a binary logic operator, for example, XOR or XNOR. As an example, BLO may indicate a standard binary operator such as XOR (exclusive OR operator), outputting for example value 1 indicating TRUE, and value 0 indicating FALSE. As a consequence, the summations in the above equation are performed on {0, 1} and can be seen as a counter of TRUE values.

As another example, D and W may represent two tensors of dimensions (h_{D}, w_{D}, c_{D}) and (h_{w}, w_{w}, c_{w}) standing for the input data and the convolution kernel, respectively. Typically, h_{D}≥h_{w} and w_{D}≥w_{w} whereas c_{D}=c_{w}. As an example. Y may indicate the result of a convolution of D and W so that element Y[m,n] of the convolution is given as follows (Eq. 3):

Y[m,n]=Σᵢ₌₀^{h}^{_{w}}⁻¹Σⱼ₌₀^{w}^{_{w}}⁻¹Σₖ₌₀^{c}^{_{w}}⁻¹BLO(D[m+i,n+j,k],W[i,j,k]),

wherein BLO may be any binary logic operator, for example as indicated above.

The binary convolution operator may be used with binary data type in straightforward manner. Due to the duality between two groups ({True, False}, XOR) and ({−1, +1}, *) wherein ‘*’ is a standard multiplier operator, the binary convolution operator, for example as defined above, may be directly applicable to binary values with multiplier operator ‘*’. An example is summarized in Table 1 below (where BLO=XOR, as a particularly efficient example).

TABLE 1

| Bool {True, False} | | Binary {−1, +1} | | Bool operator | Binary operator |
|---|---|---|---|---|---|
| X | W | X | W | BLO(X, W) | X * W |
| TRUE | TRUE | −1 | −1 | FALSE | +1 |
| TRUE | FALSE | −1 | +1 | TRUE | −1 |
| FALSE | TRUE | +1 | −1 | TRUE | −1 |
| FALSE | FALSE | +1 | +1 | FALSE | +1 |

In an embodiment, an activation (“output”) may be used to create a binary output from a pre-activation value, such as the indirect or direct result of the convolution y, for example, as follows (Eq. 4):

$$output = \{ \begin{matrix}True , & y \geq T , \\ False , & y < T\end{matrix} ,$$

The output may indicate the output of a neuron of the CNN. It may be a binary activation. A threshold value T may be used for determining the output from a pre-activation value. The threshold value T may be fixed or set as a parameter to be learnt during training of the CNN.

This design allows binary variational backpropagation for training the CNN directly in binary domain.

FIG. 5 illustrates an example of a variational backpropagation method according to an embodiment of the present disclosure. This may be used for training of the CNN. As indicated above, the training may comprise iterative loops of feed-forward and backpropagation passes. Feed-forward pass can be straightforward whereas subtle details in the context of the present disclosure may be found in the backpropagation pass. The training may be configured so that the objective of the loops is to reduce or minimize the value of a loss function which measures discrepancy between true labels and labels predicted by the CNN during the feed-forward pass. The loss function may be predefined, or fixed.

FIG. 5 may be seen to illustrate a backpropagation pass performed at a layer of the CNN. A signal Z may be received, at a neuron of the CNN, from downstream. For backpropagation, binary variational training 500 may be used at the neuron. The signal may indicate how the loss function varies with respect to a variation of each of its neurons output. It may also have access to a memory 502 which may be configured to store the pre-activation values during a preceding feed-forward pass. It may also have access to other stored information. For these purposes, a device providing the CNN may comprise one or more memories coupled to its neurons. For binary variational training, a set of rules may be performed in order to take a decision on whether to inverse a binary weight or not. Signal Z′ may also be computed for upstream transmission with respect to the neuron. The set of rules may be predefined, or fixed. The set may be common to all components of this process.

As an example, the set of rules may comprise following types of rules, any of which may be used alone or in combination with the others:
Binary signal: Binary signal may take values in {True, False}. For a binary signal b, denote by b_{bin} its dual binary signal which is given as b_{bin}=−1 for b=True, and b_{bin}=+1 for b=False. Further, denote bᵢₙₜ=1 for b=True, and bᵢₙₜ=0 for b=False.
Variation of binary signal: A binary signal b may be indicated as increasing if it passes from False to True, and as decreasing if it passes from True to False.
Real signal: Real signal may take values in the real field. For a real signal x, denote x_{boot}=(x<0), x_{bin}=sign(x), and |x| its magnitude.
Backpropagation signal: If backpropagation signal Z has value True or Z<0, it may be taken to indicate that loss function decreases with an increase of the indicated layer output. Conversely, if backpropagation signal Z has value False or Z≥0, it may be taken to indicate that loss function increases with an increase of the indicated layer output.

The above set of rules is one of various possible sets that a competent person in the field can define. Therefore, the present disclosure is not limited to this specific set of rules. Such a set of rules may be used as a common ground for establishing binary variational training throughout the process. In particular, it is noted that the backpropagation signal may indicate how a predefined loss function varies with a variation of the output of each layer. It may be binary-valued or real-valued. Also, as indicated above, a direction of variation for the binary signal may be defined for the binary variational training.

Binary variational backpropagation may be used to train the CNN directly in the binary domain. Weights of the CNN may be optimized by binary logics, which may be synthetized from the binary variational training. During the feed-forward pass, the output of a neuron may be given in accordance with Eqs. 2 and 3, as indicated above. The training may be used to optimize binary weights wᵢⱼₖ for the convolution kernel. During the backpropagation pass, the neuron in question may receive a signal Z that indicates how the loss function varies with a variation of its output. For example, if the signal Z indicates that the loss function increases with an increase of the neuron output, to make the loss function decrease, the neuron output should be decreased. Thus, to optimize a specific weight wᵢⱼₖ, its current value from the binary logic operator BLO(xᵢⱼₖ, wᵢⱼₖ) may be evaluated (as an example, BLO may be XOR). If BLO(xᵢⱼₖ, wᵢⱼₖ) is currently 1, then it suffices to inverse wᵢⱼₖ so that the new weight wᵢⱼₖ′ will result in BLO(xᵢⱼₖ, wⱼᵢₖ′)=0. According to this principle, the process of binary variational training of weights may include the following steps:
Establish a variational truth table to relate a variation of a binary weight to a variation of the loss function. Proceed with inverting a binary weight, evaluating the new outcome of the binary logic operator for the inverted weight and its corresponding input for determining how the pre-activation varies with respect to the inversion (e.g. is it increasing, decreasing, or constant). Then, utilizing the backpropagated signal, evaluate how the loss function varies (e.g. does it increase, decrease, or remain unchanged) upon this inversion of the binary weight.
Based on the variational truth table, receive (synthetized) binary logic rules that indicate under which conditions to inverse a binary weight so as to make the loss function decrease.
Follow the binary logic rules to inverse or maintain each binary weight. This binary variational principle may be used for the dual objective of loss function minimization following the (synthetized) binary logic rules.

This may be used to allow maintaining the CNN training in binary domain while correctly optimizing binary kernels. Importantly, there is no need to use the full-precision CNN with gradient descent for the training, so that the binary network would only be extracted from the trained full-precision network for the inference phase.

The backpropagation signal may also be computed in a manner different from that of the standard full-precision CNN for which backpropagation signal is the derivative of the loss function. Computation of backpropagation signal may be performed compliant with the set of rules as indicated above, following the same binary variational principle as described above for the binary variational training:
Establish a variational truth table to relate a variation of an input to a variation of the loss function taking into account the structure of the convolution kernel and the received signal Z. This may proceed substantially in the same manner as for variational training of weights.
Based on the variational truth table, receive (synthetized) binary logic rules to determine the relative variation between a variation of the input and a variation of the loss function. This results in the signal to be backpropagated to the upper layer(s).

The training of the CNN directly in the binary domain may be facilitated both by the structure of binary convolution operator: being in binary domain while maintaining the desired property of elastic activation for learnability and by the binary variational training for optimizing binary weights. In accordance with the disclosure, binary weights are used during both the training and inference phase of the CNN, without need of a full-precision version for the training. Inputs of the CNN may be binary or non-binary, for example real-valued. Non-binary input(s) for a neuron may be converted into binary data so that binary data may be used for convolution regardless of whether the input is binary or non-binary. Binary logics may be used for the convolution operation performed on the binary weights and binary data (e.g. converted or non-converted inputs). A binary activation function, such as Bool, Sign, or Step function, may be used to maintain the network in the binary domain while providing a property for learnability.

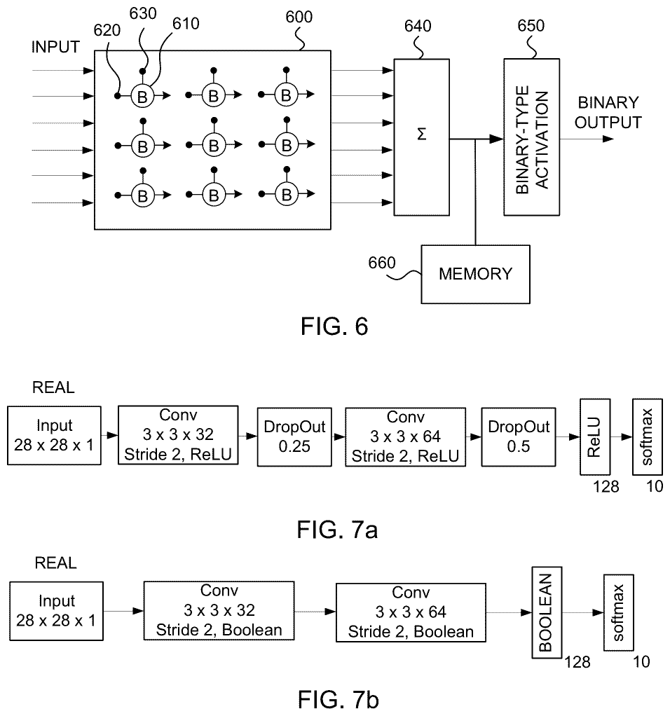

FIG. 6 illustrates an example of a hardware implementation of a binary convolution kernel 600 according to an embodiment of the present disclosure. The kernel 600 may comprise a plurality of configurable base logics. Each configurable base logic may comprise a feeding receptor 620 for providing an input of the neuron, a configurable bit 630 for implementing the respective binary weight, and a convolution operator 620 coupled to the feeding receptor and the configurable bit for performing a convolution operation with respect to the input and the respective binary weight. The convolution operation may be as described above, for example, XOR, AND, OR and/or XNOR. The input here may be a converted or non-converted input, depending on whether the initial input to the neuron is a binary input or a non-binary input. Correspondingly, the kernel 600 or the configurable base logic may comprise a conversion unit for converting the input to binary data. The convolution operator may be configured for performing the convolution with respect of two sets of binary data, i.e. the binary weights and the (non-) converted binary inputs. The plurality of configurable base logics may be arranged according to a specified layout, for example, a rectangular layout such as a square layout. For activation, a pre-activation gate 640, such as a summation gate, may be coupled to the kernel 600 for providing a pre-activation from the outputs of the configurable base logics. A binary-type activation gate 650 may be coupled to the pre-activation gate 640 for providing an activation from the pre-activation. The activation may be provided as the output of the neuron. The activation may be provided as binary-valued. A memory 660 may be coupled to the pre-activation gate 640 for storing pre-activation values. The activation part, including the pre-activation gate 640 and/or the activation gate 650, can be incorporated within the convolution kernel 600 or be implemented as a separated part.

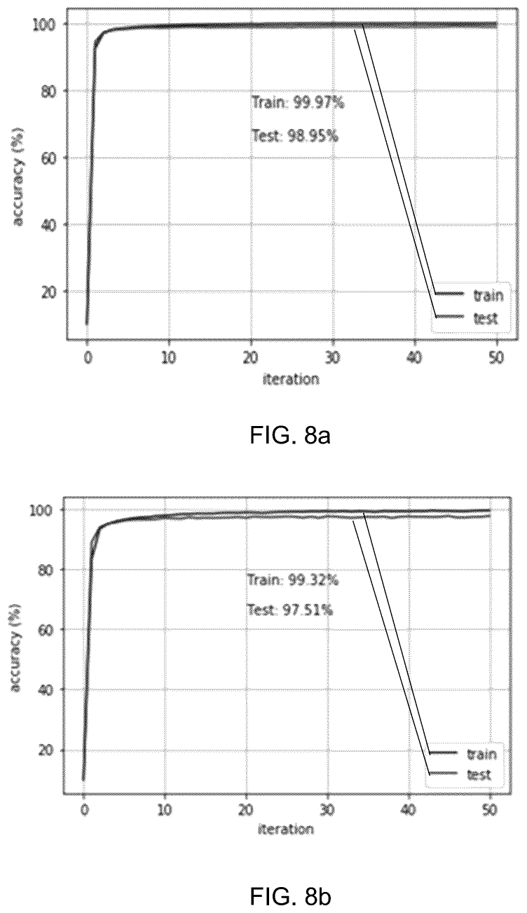

FIGS. 7a and 7b illustrate examples of a topology for configuring a full-precision CNN and a topology for binary configuration of a CNN according to an embodiment of the present disclosure, respectively. This provides an example of a performance test. In the test, a solution (CONV BOOLNET) in accordance with the present disclosure (FIG. 7b) is compared against a full-precision CNN. The full-precision CNN is configured with an optimal topology as shown in FIG. 7a. For fair comparison, CONV BOOLNET is set to the topology as shown in FIG. 7b, which also has an exception in that it does not include DropOut layers. Both networks are tested with MNIST dataset and their performance is shown in FIG. 8a and FIG. 8b, in the corresponding order. As indicated, CONV BOOLNET may achieve at least a comparable performance with the full-precision CNN, while reducing the training memory into a fraction of 1/64. It is noteworthy that the above topology is the architecture which has been heavily optimized by the deep learning community for the full-precision CNN. This topology, clearly, may not necessarily be optimal for CONV BOOLNET. Hence, any performance gap between CONV BOOLNET and full-precision CNN is expected to be reduced for an optimal topology of CONV BOOLNET. It has also been found that CONV BOOLNET may allow providing numerical stability, where the full-precision network encounters severe numerical instability in gradient computation as well as in log, inverse, and exponential operations.

In the following, three examples are provided. For all these examples the set of (common) rules as described above is utilized.

### Example 1: Binary Input with Binary Kernel with XOR Logic

In this case, input x and weight w are binary, while the backpropagation signal Z can be real or binary.

a) Binary Variational Training of Weights

TABLE 2
Variational truth table.

| | | | | | | Loss variation | |
|---|---|---|---|---|---|---|---|
| | | | | | Variation | Z = False | Z = True |
| x | w | w′ | xw | xw′ | of xw | or Z > 0 | or Z < 0 |
| True | True | False | 0 | 1 | Increase | Increase | Decrease |
| True | False | True | 1 | 0 | Decrease | Decrease | Increase |
| False | True | False | 1 | 0 | Decrease | Decrease | Increase |
| False | False | True | 0 | 1 | Increase | Increase | Decrease |

Synthetized Logic:

If XOR(x, w, z_{bool})=True, then Inverse w.

Processing Steps:
1) Initialize variational_momentum to 0 with the same dimensions of weight kernel;
2) Compute: p=XOR(x, z_{bool});
3) Compute: p=(−1)p=x_{bin} z_{bin};
4) If z is real signal, incorporate |z| to p: p←|z|. p=z·x_{bin};
5) Incorporate activation effect v to p: p←v·p;
6) Take the sum of p over batch dimension: q:=sum(p over batch dimension);
7) Add q to variational_momentum memory;
8) Get indices: I0=(w=False and variational_momentum<=−1), I1=(w=True and variational_momentum>=1);
9) Inverse w at indices I0 and I1;
10) Reset variational_momentum at indices I0 and I1 to 0.

Remarks:
For binary input and weights, then skip step (2).
If z is real, then can directly compute p from step (4).

If the activation function is differentiable, activation effect v is actually the derivative of the activation function taken at the pre-activation value. However, in the interest of our disclosure, Bool (also called Threshold) activation may be used. In this case, v may be any factor which is used to indicate how the pre-activation value is far from the threshold. In our embodiment, v can be approximated by 0.5*tanh′ or sigmoid′.

b) Binary Variational Backpropagation

This is to compute the signal to be backpropagated to the upstream.

TABLE 3

| | | | | | | | | | Loss variation | |
|---|---|---|---|---|---|---|---|---|---|---|
| | | | | | | | Loss variation | | vs x | |
| | | Variation | | | | Variation | Z = False | Z = True | Z = False | Z = True |
| x | x′ | of x | w | wx | wx′ | of xw | or Z > 0 | or Z < 0 | or Z > 0 | or Z < 0 |
| TF | | Decrease | T | 0 | 1 | Increase | Inc | Dec | Dec | Inc |
| T | F | Decrease | F | 1 | 0 | Decrease | Dec | Inc | Inc | Dec |
| F | T | Increase | T | 1 | 0 | Decrease | Dec | Inc | Dec | Inc |
| F | T | Increase | F | 0 | 1 | Increase | Inc | Dec | Inc | Dec |

(T = True, F = False, Inc = Increase, Dec = Decrease)

Synthetized Logic:

Backpropagation signal=XOR(w, z_{bool});

Processing steps:
1) Compute: p=XOR(w, z_{bool});
2) Compute: p=(−1)^{p}=w_{bin}·z_{bin};
3) If z is real signal, then incorporate |z|: p←|z|·p=z·w_{bin};
4) Incorporate activation derivative: p←v·p;
5) Take sum of p over layer dimension: q=sum(p over layer output dimension);
6) Back propagate q for real-valued backprop signal, or q_{bool}=(q<0) for bool backprop signal.

Remarks:
For binary input and weights, then skip step (1).
If z is real, then can directly compute p from step (3).

### Example 2: Binary Input with Binary Kernel with XOR Logic

In this case, input x and weight w are binary, while the backpropagation signal Z can be real or binary.

a) Binary Variational Training of Weights

TABLE 4
Variational truth table.

| | | | | | Variation | Loss variation | |
|---|---|---|---|---|---|---|---|
| x | w | w′ | xw | xw′ | of xw | Z = False | Z = True |
| | | | | | | or Z > 0 | or Z < 0 |
| True | True | False | 1 | 0 | Decrease | Decrease | Increase |
| True | False | True | 0 | 1 | Increase | Increase | Decrease |
| False | True | False | 0 | 0 | — | — | — |
| False | False | True | 0 | 0 | — | — | — |

Synthetized Logic:
If x=False: Ignore
If x=True: If XOR(z_{bool}, w)=True, then Inverse w.

Processing Steps:
1) Initialize variational_momentum to 0 with the same dimensions of weight kernel;
2) Get: p=z_{bin};
3) If z is real signal, then incorporate |z|: p←|z|·p=z;
4) Incorporate activation derivative v: p←v·p;
5) Compute: p=xᵢₙₜ·p→this is to null out x=False;
6) Take the sum of p over batch dimension: q=sum(p over batch);
7) Add q to variational_momentum memory;
8) Get indices: I0=(w=False and variational_momentum<=−1), I1=(w=True and variational_momentum>=1);
9) Inverse w at indices I0 and I1;
10) Reset variational_momentum at indices I0 and I1 to 0.

b) Binary Variational Backpropagation

TABLE 5

| | | | | | | | Loss variation | | Loss variation vs x | |
|---|---|---|---|---|---|---|---|---|---|---|
| | | Variation | | | | Variation | Z = False | Z = True | Z = False | Z = True |
| x | x′ | of x | w | wx | wx′ | of wx′ | or Z > 0 | or Z < 0 | or Z > 0 | or Z < 0 |
| T | F | Decrease | T | 1 | 0 | Decrease | Dec | Inc | Inc | Dec |
| T | F | Decrease | F | 0 | 0 | — | — | — | — | — |
| F | T | Increase | T | 0 | 1 | Increase | Inc | Dec | Inc | Dec |
| F | T | Increase | F | 0 | 0 | — | — | — | — | — |

(T = True, F = False, Inc = Increase, Dec = Decrease)

Synthetized Logic:
If w=False: ignore (or variation=0);
If w=True: backprop=z_{bool}.

Processing Steps:
1) Get: p=z_{bool};
2) Get: p=(−1)^{P}=z_{bin};
3) If z is real signal, then incorporate |z|: p←|z|·p=z;
4) Incorporate activation derivative: p←v·p;
5) Compute: p=wᵢₙₜ·p→this is to null out w=False;
6) Take sum over layer output dimension: q=sum(p over layer output dimension);
7) Back propagate q for real-valued backprop signal, or g_{bool}=(q<0) for bool backprop signal.

Remark:
For real signal z, steps (1-5) can be performed in one step: p=wᵢₙₜ·v·z.

### Example 3: Real Input with Binary Kernel

In this case, input data x is real, convolution kernel w is binary, and convolution operator is the standard real arithmetic convolution.

a) Binary Variational Training of Weights

TABLE 6
Variational truth table.

| | | | | | | Loss variation | |
|---|---|---|---|---|---|---|---|
| | | | | | Variation | Z = False | Z = True |
| x | w | w′ | xw | xw′ | of xw | or Z > 0 | or Z < 0 |
| − | True | False | x | 0 | Increase | Increase | Decrease |
| − | False | True | 0 | x | Decrease | Decrease | Increase |
| + | True | False | x | 0 | Decrease | Decrease | Increase |
| + | False | True | 0 | x | Increase | Increase | Decrease |

Remark: This example has a variational truth table directly corresponding that of example 1.

Synthetized Logic:

If XOR(x_{bool}, w, z_{bool})=True, then Inverse w.

Processing Steps:
1) Initialize variational_momentum to 0 with the same dimensions of weight kernel;
2) Compute: p=XOR(x_{bool}, z_{bool});
3) Compute: p=(−1)^{p}=x_{bin} z_{bin};
4) Incorporate |x|: p←|x|·p=x·z_{bin};
5) If z is real signal, incorporate |z| to p: p←|z|·p=z·x→similar to a Real layer;
6) Incorporate activation effect v to p: p←v·p;
7) Take the sum of p over batch dimension: q:=sum(p over batch dimension);
8) Add q to variational_momentum memory;
9) Get indices: I0=(w=False and variational_momentum<=−1), I1=(w=True and variational_momentum>=1);
10) Inverse w at indices I0 and I1;
11) Reset variational_momentum at indices I0 and I1 to 0.

Remarks:
Go directly to step (4).
Further, if z is real, then can go directly to step (5).
This process may be directly applied to binary data type.

c) Binary Variational Backpropagation

TABLE 7

| | | | | | | | Loss variation | |
|---|---|---|---|---|---|---|---|---|
| | | | | | Loss variation | | vs x | |
| | Variation | | | Variation | Z = False | Z = True | Z = False | Z = True |
| x | of x | w | wx | of wx | or Z > 0 | or Z < 0 | or Z > 0 | or Z < 0 |
| − | Increase | True | x | Increase | Inc | Dec | Inc | Dec |
| − | Increase | False | 0 | — | — | — | — | — |
| + | Increase | True | x | Increase | Inc | Dec | Inc | Dec |
| + | Increase | False | 0 | — | — | — | — | — |

(Inc = Increase, Dec = Decrease)

### Synthetized Logic:

If w=False: ignore (or variation=0);
If w=True: backprop=z_{bool}.
   Remark: this directly corresponds to Example 2.

### Processing Steps:

Follow those of Example 2.

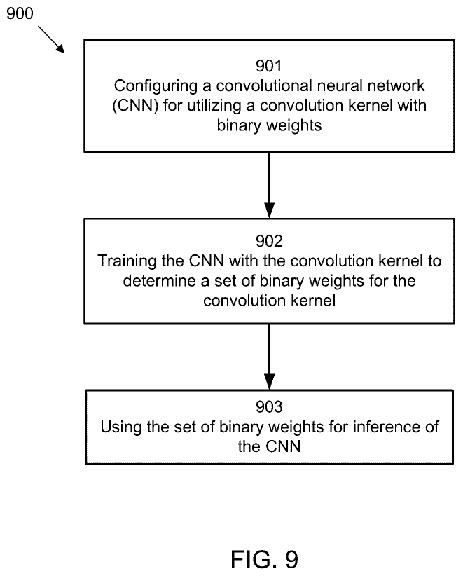

FIG. 9 illustrates an example of a method 900 for processing a CNN according to an embodiment of the present disclosure.

At 901, the method may comprise configuring the CNN for utilizing a convolution kernel with binary weights.

At 902, the method may comprise training the CNN with the convolution kernel to determine a set of binary weights for the convolution kernel.

At 903, the method may comprise using the set of binary weights for inference of the C

Further features of the method 900 directly result from the functionality of the device 300 configured to provide and/or train binary neural network(s), as described in the appended claims and throughout the specification, and are therefore not repeated here. Different variations of the methods may be also applied, as described in connection with the various example embodiments.

The CNN (also simply “the neural network”) according to an embodiment of the present disclosure may comprise an input layer with neurons i₁ to iᵢ and an output layer comprising neurons o₁ to oⱼ. Between the input and output layers there may be one or more hidden layers, in this example first, second, and third hidden layers. Neurons, B, of the first hidden layer may be connected to one or more neurons of the second hidden layer. Neurons of the of the second hidden layer may be connected to one or more neurons of the third hidden layer. A neural network may have any number and any type of hidden layers. Considering the second hidden layers as reference, the third layer may be called a downstream layer since it is located towards the output layer. The first hidden layer may be called an upstream layer with respect to the considered (second) layer, since it is located towards the input layer. In standard terminology, a feed-forward neural network may be a multi-layer perceptron, which only contains 1D layer and hence may only process vector-type data. However, a CNN, as disclosed herein, is convolutional and may comprise 2D layer(s) for processing of 2D data such as images. Both feed-forward NN and CNN may be considered as sequential architectures in which layers are connected one after another in a sequential order from the input to the output. There needs to be no loop-back, such as in recurrent neural networks. It is appreciated that the embodiments of the present disclosure may be applied to any suitable type of CNN. The neural network may be provided on the device 200, for example, stored in the at least one memory 204 such that the neural network may be trained and/or executed on the device 200. The neurons B may comprise binary neurons. For example, they may take as inputs one or more binary inputs and provide a binary output.

According to an embodiment, an input to the neural network may comprise an image. The neural network may be, for example, configured to classify images or recognize and/or classify objects in the images. According to an embodiment, an input to the neural network may comprise autonomous navigation data, such as for example, information about a location or a speed of a vehicle, data captured by one or more sensors of the vehicle such as for example a camera, a radar, a lidar, or the like. The neural network may be configured to determine navigation or control instructions to the vehicle. The neural network may be implemented at an edge device of a communication network, for example at an edge of a core network connected to a device, for example a mobile phone or a car, by a radio access network.

The CNN as disclosed involves neurons which are binary neurons. A design of the binary neuron according to an embodiment of the present disclosure may satisfy the following criteria. First, operation of the Boolean neuron may stay within the binary field, including weights, but also for example, the input(s) and/or the output(s). Second, the binary neuron may have an activation function which possesses non-linearity property, thereby enabling the neural network to generalize to unseen data. A neuron is an example of the binary neurons, B, of the neural network. The neuron may be provided with binary weights w₀, w₁, . . . , wₘ and inputs b₁, b₂, . . . , bₘ, where m is the number of inputs. The inputs are optionally binary. The neuron may further take as an input a bias w₀, which may be a binary bias. Denoting by BLO a binary logic operator (function), a pre-activation y of the neuron may be therefore given for example as follows (Eq. 5):

y=w₀+Σᵢ₌₁^{m}BLO(bᵢ,wᵢ),

The binary operator BLO (also “binary function) may comprise for example an AND, an OR, a NAND, a NOR, XNOR (exclusive-NOR) or an XOR (exclusive-OR) operator. The exclusive-OR operation may be also denoted by “⊕”. The neuron may evaluate a binary function BLO(bᵢ, wᵢ) for each of the binary weights and the respective inputs. An input of the binary function BLO(bᵢ, wᵢ) may comprises a binary weight wᵢ and a respective input bᵢ. The neuron may further determine the pre-activation value based on a sum of at least outputs of the binary function, when the binary function is evaluated for each of the binary weights and the respective inputs. Correspondingly, determining whether the binary function increases or decreases corresponds to determining whether the pre-activation function increases or decreases. The neuron may further determine the pre-activation value based on the sum of the binary outputs of the Boolean function and the binary bias w₀. Since the pre-activation may be determined based on a sum of binary values, the pre-activation may in general comprise an integer number. However, embodiments of the present disclosure enable processing of the pre-activation in the binary domain, which will reduce complexity of the neural network.

The pre-activation in accordance with the present disclosure may be further processed by an activation function. The activation function may in general comprise any function that maps the pre-activation from a value, such as an integer value to an output, which may be a binary output. The activation function may therefore comprise a binary activation function. It is noted that according to embodiments of the present disclosure the pre-activation may be only conceptually an integer value, while in a hardware implementation of the neuron the associated signals may be binary. According to an example embodiment, the activation function may comprise a threshold function. The threshold function may be applied on the pre-activation y to provide a Boolean value as on output, for example in accordance with Eq. 4, where T is the threshold for the pre-activation value y. Threshold T may be an integer number. The following condition may hold for the threshold: 0<T<m. Threshold T may be therefore a positive number which is smaller than the number of inputs of the neuron. The neuron may therefore determine the binary output based on the threshold for the pre-activation value.

As an example of a hardware implementation of a binary neuron, according to an embodiment of the present disclosure, the neuron may comprise a logic threshold gate (LTG). Considering Eq. 5, in the pre-activation part the binary inputs may be temporarily passed from the binary domain to the integer domain. This enables to use an activation function which possesses non-linearity property. However, this may not be always desired since it may conflict with the objective of keeping the neuron completely in the binary domain. This may be however avoided by applying particular type of hardware, for example a logic threshold gate (LTG). An LTG includes both summation and decision in such a way that the decision can be made within the gate itself, and thereby a pure binary output may be directly produced from the binary inputs. An LTG may be therefore configured to implement both the sum of Eq. 5 and the threshold-based activation function. This enables a simple hardware implementation by a single LTG. Furthermore, this enables to keep the calculation in the binary domain. As a result, CNNs built based on neuron may be made purely binary.

The binary inputs bᵢ and the respective weights wᵢ of the neuron may be provided by a plurality of logic gates. The outputs of the logic gates may be connected to the LTG. In this example, the logic gates comprise XOR gates, but it is noted that any other suitable logic operators may be applied instead. The LTG may take as a further input the binary bias w₀. The LTG may be therefore configured to take as input the binary outputs of the binary function. The LTG may be configured with the threshold T. The LTG may therefore provide the binary output.

According to an example embodiment, the output of the neuron may be determined for example as follows (Eq. 6):

$$output = \{ \begin{matrix}TRUE , & if {w}_{0} + {\sum }_{i = 1}^{m} BLO ( {b}_{i} , {w}_{i} ) \geq T , \\ FALSE , & if {w}_{0} + {\sum }_{i = 1}^{m} BLO ( {b}_{i} , {w}_{i} ) < T\end{matrix} ,$$

The threshold T may be for example set to T=(m+1)/2. BLO may be, for example, XOR.

According to an embodiment of the present disclosure, variational backpropagation enables training of a binary CNN in the binary domain with synthetized binary logics. An example of operations for performing a backpropagation pass at a layer is provided as follows. A neuron of a considered layer, for example, the second hidden layer of neural network, may receive a binary backpropagation signal Z from a downstream layer. Signal Z may comprise a binary signal indicating how the loss function varies with respect to each neuron output. When valued as a first binary value such as FALSE, Z may indicate that the loss function increases with respect to the neuron output. When Z is valued as a second binary value (mutually exclusive with respect to the first binary value), such as TRUE, it may indicate that the loss function decreases with respect to the neuron output. In this regard, neuron output may be called increasing if it passes from the second binary value to the first binary value. The neuron output may be called decreasing if it passes from the first binary value to the second binary value.

An operation for variational backpropagation may comprise variational training of weights. The operation may take the received binary backpropagation signal Z as input and take into account the neuron function in order to establish a binary variational truth table of the variational relations between each binary weight and the loss function. Based on the truth table it is possible to determine synthesis rules (or logics) so as to make a final decision on whether to change or to keep each binary weight at a training iteration. Upon the synthetized logics given from the variational training at operation, weights of each neuron may be adapted accordingly.

An operation for variational backpropagation may comprise computing a binary backpropagation signal Z′ for the upstream layer. This signal may have the same specification as that of the signal Z. For example, the purpose is to send the first binary value if the loss function increases with neuron's input, and the second binary value otherwise. For that, a truth table of the variational relation between the loss function and neuron's inputs may be established so as to synthetize logics for determining the backpropagation signal Z′. This variational backpropagation method has at least the following advantages: Its variational principle may be applied directly at the Boolean domain and may be used to replace the gradient descent method for binary CNNs. It also has all desired features of the gradient descent method such as for example being suitable for mini-batch training, in which not one data sample but a subset of data samples is used for one training iteration. Furthermore, it enables to train binary CNN completely in the binary domain with binary logics, hence achieving the goal of designing purely binary CNNs and thereby greatly reducing memory and computational energy.

In variational backpropagation, a binary backpropagation signal specifying how a predefined loss function varies with the neuron output may be used to adapt binary weights. A decision for changing or keeping binary weights can be made based on logic rules which may be synthesized from a variational truth table. Variational backpropagation may further comprise computing a signal to be backpropagated to an upper layer based on logic rules which may be synthesized from the updated weights, neuron function, and the received backpropagation signals.

Layers of a neural network may comprise one or multiple neurons. For example, a neuron of a considered layer may receive a binary backpropagation signal Z from one or more neurons (1 . . . N) of the corresponding downstream layer. For one training data sample, the neuron may receive a backpropagation signal zⱼ from the jth neuron of the downstream layer. As described above, signal zⱼ may be a binary number. Let N be the number of neurons of the downstream layer, the neuron may receive a backpropagated signal vector Z=[z₁, . . . , zⱼ, . . . , z_{N}] for one training data sample. The binary backpropagation signal(s) zⱼ may indicate a tendency of a loss function with respect to a variation of a binary output of the neuron. As discussed above, the neuron may be configured with binary weights associated with respective inputs, which may be binary inputs. The tendency of the loss function with respect to the variation of the output of the neuron, which may be binary output, may indicate whether variation of the output of the neuron causes the loss function to increase or decrease.

During training the binary function (or, correspondingly, the pre-activation function) of the neuron may be evaluated based on an input comprising an ith binary weight of the neuron and a respective input of the neuron. Furthermore, a tendency of the binary function (or, correspondingly, the pre-activation function) with respect to inversion of the ith binary weight may be determined and finally a decision may be made whether to invert the ith binary weight. Determining whether to invert the ith binary weight may be based on the tendency of the binary function (or the pre-activation function) with respect to the inversion of the ith binary weight and the tendency of the loss function with respect to the variation of the output of the neuron, as will be further described below. The tendency of the binary function (or the pre-activation function) with respect to the inversion of the ith binary weight may indicate whether the inversion causes the binary function (or the pre-activation function) to increase or decrease.

Based on a truth table, it is possible to determine the variation of the loss function, e.g., the tendency of the loss function of with respect to variation of the output of the neuron. For example, if the received binary backpropagation signal zⱼ corresponds to the first binary value, such as FALSE, indicating that the loss increases with the output of the neuron, then the loss increases with BLO(bᵢ, wᵢ). Conversely, if the received signal zⱼ corresponds to the second binary value, such as TRUE, indicating that the loss decreases when the output of the neuron, the loss decreases when BLO(bᵢ, wᵢ) increases. Here, BLO may be, for example, XOR.

For example, the variational training may comprise determining that the inversion of wᵢ causes the loss function to increase if the pre-activation function, or the binary function such as BLO, increases with respect to inversion of wᵢ and the loss function increases with respect to the output of the neuron.

The variational training may further comprise determining that the inversion of wᵢ causes the loss function to decrease if the pre-activation function, or the binary function such as BLO, increases with respect to inversion of wᵢ and the loss function decreases with respect to the output of the neuron.

The variational training may further comprise determining that the inversion of wᵢ causes the loss function to decreases if the pre-activation function, or the binary function such as BLO, decreases with respect to inversion of wᵢ and the loss function increases with respect to the output of the neuron.

The variational training may further comprise determining that the inversion of wᵢ causes the loss function to increase if the pre-activation function, or the binary function such as BLO, decreases with respect to inversion of wᵢ and the loss function decreases with respect to the output of the neuron.

Since an objective may be to minimize the loss function, the ith weight wᵢ of the neuron may be arranged to be changed only if the change results in a reduction of the loss. Therefore, the training may comprise determining to invert wᵢ, in response to determining that the inversion of wᵢ causes the loss function to decrease. The training may further comprise determining not to invert wᵢ, in response to determining that the inversion of wᵢ causes the loss function to increase. Considering the signal backpropagated from only one neuron, the logic may be synthetized for example as follows: Put vⱼ: =BLO(xᵢ, zⱼ), where xᵢ=BLO(bᵢ, wᵢ). If vⱼ equals TRUE, then reverse wᵢ; otherwise keep wᵢ.

Neuron(s) of the trained neural network may be configured, for example, to evaluate a binary function (e.g. XOR) for each binary weight of the neuron and the respective input. The neuron(s) may further determine pre-activation value(s) based on a sum of at least binary outputs of the binary function, when the binary function is evaluated for each of the binary weights and the respective inputs. The neuron(s) may be further configured to determine output, which may be a binary output, of neuron(s) based on a threshold for the pre-activation value, as discussed above. The neuron(s) may be implemented for example based on the logic threshold gate.

However, there may be multiple neurons at the downstream layer. These neurons may backpropagate different signals (Z=[z₁, . . . , zⱼ, . . . , z_{N}]). Therefore, the training may comprise combining a plurality of binary backpropagation signals. In other words, determining whether to invert the ith binary weight may be based on a combination of the plurality of binary backpropagation signals. For example, the neuron may receive the plurality of binary backpropagation signals (Z=[z₁, . . . , zⱼ, . . . , z_{N}]) from a corresponding plurality of neurons of the downstream layer. Training of the neuron may comprise determining a number of backpropagation signals indicative of inversion of wᵢ and a number of binary backpropagation signals indicative of non-inversion of w₁. For example, the training may comprise computing a current xᵢ:=BLO(bᵢ, wᵢ); computing vⱼ:=BLO(xᵢ,zⱼ) for a plurality of zⱼ; and counting in N_{FALSE} the number of vⱼ=FALSE and in N_{TRUE} the number of vⱼ=TRUE.

The variational training may further comprise determining to invert wᵢ, if the number of binary backpropagation signals indicative of the inversion of the wᵢ is higher than the number of binary backpropagation signals indicative of non-inversion of w₁. The variational training may further comprise determining not to invert wᵢ, if the number of binary backpropagation signals indicative of the inversion of wᵢ is lower than (or equal to) the number of binary backpropagation signals indicative of non-inversion of wᵢ. For example, wᵢ may be reversed (inverted) if N_{FALSE}>N_{TRUE}. Otherwise, the current value of wᵢ may be kept (not inverted).

With the weights updated at the operation of variational backpropagation, for example as described above, it is possible to compute the ith binary backpropagation signal uᵢ^{j} for the upstream layer, for example the first layer of the CNN. Index i may refer to the ith input and the ith weight of the neuron of the considered layer, for example, the neuron. Hence, index i may also refer to the index of the neuron of the upstream layer to which the ith binary upstream backpropagation signal is provided. Index j may refer to the jth neuron of the downstream layer. The binary backpropagation signal may be determined such that the signal corresponds to a first binary value, such as FALSE, if the loss function increases with the input, and to a second (mutually exclusive) binary value, such as TRUE, otherwise. Signal uᵢ^{j} may be a signal that is temporarily calculated to determine the final binary upstream backpropagation signal uᵢ based on the different uᵢ^{j} corresponding to different zⱼ.

In order to determine the value of the upstream binary backpropagation signal(s), a variational analysis may be performed.

The ith binary upstream backpropagation signal uᵢ^{j} may be set to correspond to the first binary value, such as FALSE if the loss function increases with input of the neuron, and to the second binary value, such as TRUE, otherwise. For example, determining uᵢ^{j} may be based on a tendency of the loss function with respect to a variation of the ith binary input, bᵢ. For example, uᵢ^{j} may be set to the first binary value if the loss function increases with respect to an increase of bᵢ. And, uᵢ^{j} may be set to the second binary value if the loss function does not increase with respect to the increase of b₁. Training of the neurons of the upstream layer may be then performed based on uᵢ^{j}, similar to training of the neuron of the considered layer. This way the binary weights of the entire neural network may be updated while keeping the required computations in the binary domain.

As discussed above, there may be a plurality of neurons at the downstream layer and these neurons may send independent binary backpropagation signals zⱼ, where j=1, . . . , N. Therefore, the synthetized binary logic of the variational truth table may be combined over different backpropagation signals zⱼ. For example, determining uᵢ^{j} may comprise determining a number of binary backpropagation signals zⱼ indicative of setting u to the first binary value. The jth binary backpropagation signal zⱼ may be determined to be indicative of setting uᵢ^{j} to the first binary value, if the loss function increases with respect to the increase of bᵢ. Furthermore, a number of zⱼ indicative of setting uᵢ^{j} to the second binary value may be determined, for example based on the loss function not increasing with respect to the increase of bᵢ. The (combined) binary backpropagation signal uᵢ may be then set to the first binary value, if the number of zⱼ indicative of setting uᵢ^{j} to the first binary value is higher than (or equal to) the number of zⱼ indicative of setting uᵢ^{j} to the second binary value. The binary backpropagation signal uᵢ may be set to the second binary value, if the number of zⱼ indicative of setting uᵢ^{j} to the first binary value is lower than the number of zⱼ indicative of setting uᵢ^{j} to the second binary value.

The determination of the upstream backpropagation signal uᵢ may for example comprise computing uᵢ^{j}=BLO(wᵢ, zⱼ) for a plurality of zⱼ; counting in N_{FALSE} the number of uᵢ^{j}=FALSE and in N_{TRUE} the number of uᵢ^{j}=TRUE; and if N_{FALSE}>N_{TRUE}, then send signal uᵢ =FALSE, otherwise send uᵢ=TRUE to the upper layer. This enables backpropagation signals from all or multiple neurons of the downstream layer to be taken into account when determining the upstream backpropagation signals.

According to an example embodiment, variational backpropagation may be applied with mini-batch training which uses not only one but multiple data samples in each training loop, the backpropagation signal Z may be therefore a matrix over data samples. For example, for dth data sample: the feed-forward input to the neuron may be b₁^{d}, . . . , bₘ^{d}. The received binary backpropagation signal may be Z^{d}=[z₁^{d}, . . . , zⱼ^{d}, . . . , z_{N}^{d}]. The neuron may therefore receive receiving a plurality of binary backpropagation signals from each of a plurality of neurons of the downstream layer. And, each of the plurality of binary backpropagation signals may correspond to a plurality of data samples of a mini-batch.

In one example, the pre-activation value of the neuron may be incorporated into the synthetized logics so as to achieve improved performance. A data sample specific pre-activation value of the neuron 812 may be determined for each of a plurality of data samples. Similar to above, the number of backpropagation signals indicative of inversion of wᵢ and the number of binary backpropagation signals indicative of non-inversion of wᵢ may be determined. However, these numbers may be determined for each of the plurality of data samples. For each of the plurality of data samples d, the number of backpropagation signals indicative of inversion of wᵢ and the number of binary backpropagation signals indicative of non-inversion of wᵢ may be then scaled with a function ƒ. The function ƒ, which may be called a scaling function, may be configured to take as input a difference between the data-sample specific pre-activation value s^{d} and the threshold for the pre-activation value T, for example, the predefined threshold configured for a logic threshold gate. For example, let δ^{d}:=s^{d}−T. The scaling function may then take δ^{d} as an input. The scaling function may comprise any suitable function that represents a gradient of the activation function. Two examples of the scaling function are

$$f ( x ) = \frac{1}{x}$$

and ƒ(x)=sigmoid′(x), where sigmoid′(x) is the derivative of the sigmoid function at x. However, many other approximations may be used for ƒ.

By applying the scaling function to the number of backpropagation signals indicative of inversion of wᵢ and the number of binary backpropagation signals indicative of non-inversion of wᵢ, scaled numbers of the number of backpropagation signals indicative of inversion of wᵢ and the number of binary backpropagation signals indicative of non-inversion of wᵢ may be obtained. The ith binary weight wᵢ may be then determined to be inverted, if a sum of the scaled numbers of the binary backpropagation signals indicative of inversion of wᵢ is higher than a sum of the scaled numbers of the binary backpropagation signals indicative of non-inversion of wᵢ. The ith binary weight wᵢ may be determined not to be inverted, if the sum of the scaled numbers of the binary backpropagation signals indicative of inversion of wᵢ is lower than (or equal to) the sum of the scaled numbers of the binary backpropagation signals indicative of non-inversion of wᵢ.

For example, variational training of weight wᵢ with mini-batch may comprise computing vⱼ^{d}=BLO(xᵢ^{d}, zⱼ^{d}) where xᵢ^{d}:=BLO(bᵢ^{d}, wᵢ) for a plurality of neurons j and data samples d; for each data sample d, counting in N₀^{d} the number of vⱼ^{d}=FALSE and in N₁^{d} the number of vⱼ^{d}=TRUE; for each data sample d, computing δ^{d} for example based on δ^{d}:=s^{d}−T; and determining to reverse (invert) wᵢ if Σ_{d} N₀^{d}ƒ(δ^{d})>Σ_{d} N₁^{d}ƒ(δ^{d}) and determining to keep (not invert) wᵢ otherwise.

Variational backpropagation with mini-batch training may also comprise determining binary backpropagation signal(s) for the upstream layer. The procedure for determining the upstream binary backpropagation, as described above, may be extended to the mini-batch training similar to training the weights. For example, a number of binary backpropagation signals uᵢ^{j,d} indicative of setting the ith binary upstream backpropagation signal to the first binary value may be determined for each of the plurality of data samples d. A number of binary backpropagation signals uᵢ^{j,d} indicative of setting the ith binary upstream backpropagation signal to the second binary value may be also determined for each of the plurality of data samples d. A binary upstream backpropagation signal may be determined to be indicative of setting the ith binary upstream backpropagation signal to the first binary value, if the loss function increases with respect to an increase of the ith binary input. A binary upstream backpropagation signal may be determined to be indicative of setting the ith binary upstream backpropagation signal to the second binary value, if the loss function does not increase with respect to the increase of the ith binary input.

The number of backpropagation signals uᵢ^{j,d} indicative of setting the ith binary upstream backpropagation signal to the first or second binary value may be scaled with the scaling function ƒ. The ith binary upstream backpropagation signal may be determined to be set to the first binary value, if the sum of the scaled numbers of binary backpropagation signals indicative of setting the ith binary upstream backpropagation signal to the first binary value is higher than or equal to a sum of the scaled numbers of binary backpropagation signals indicative of setting the ith binary upstream backpropagation signal to the second binary value. And, the ith binary upstream backpropagation signal may be determined to be set the second binary value, if a sum of the numbers of binary backpropagation signals indicative of setting the ith binary upstream backpropagation signal to the first binary value is lower than the sum of the numbers of binary backpropagation signals indicative of setting the ith binary upstream backpropagation signal to the second binary value. In this embodiment, the numbers of backpropagation signals indicative of setting the ith binary backpropagation signal to the first or second binary value may be counted over not only the different neurons of the downstream layer but also over the different data samples, which enables the neural network to be efficiently trained using a mini-batch.

For example, determining the (combined) binary backpropagation signal uᵢ may comprise: for each binary input i, computing uᵢ^{j,d}=BLO(wᵢ, zⱼ^{d}) for a plurality neurons j and a plurality of data samples d; for each data sample d, counting in N₀^{d} the number of uᵢ^{j,d}=FALSE and in N₁^{d} the number of uᵢ^{j,d}=TRUE; and sending to the upstream layer signal uᵢ=FALSE if Σ_{d} N₀^{d}ƒ(δ^{d})>Σ_{d} N₁^{d}ƒ(δ^{d}) and otherwise sending uᵢ=TRUE to the upstream layer.

Embodiments disclosed herein therefore provide a low-complex implementation of a neural network based on binary neurons that may be implemented with simple logic threshold gates. Methods that enable training the neural network in binary domain are also disclosed both for training based on individual data samples and a mini-batch of data samples.

A device may be configured to perform or cause performance of any aspect of the method(s) described herein. Further, a computer program may comprise program code configured to cause performance of an aspect of the method(s) described herein, then the computer program is executed on a computer. Further, the computer program product may comprise a computer readable storage medium storing program code thereon, the program code comprising instruction for performing any aspect of the method(s) described herein. Further, a device may comprise means for performing any aspect of the method(s) described herein. According to an example embodiment, the means comprises at least one processor, and memory including program code, the at least one processor, and program code configured to, when executed by the at least one processor, cause performance of any aspect of the method(s).

For example, a device may be configured to perform variational training of a binary neural network, as disclosed herein. Additionally, a method may comprise providing and/or performing inference with the binary neural network(s) described herein. A method for training a neural network may comprise a method for manufacturing the neural network.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks, operations, or elements may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the methods, blocks, operations, or elements identified, but that such items do not comprise an exclusive list and a method or device may contain additional blocks, operations, and/or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A device (300) for processing a convolutional neural network, CNN, the device (300) being configured to:
provide the CNN, wherein the CNN has a convolution kernel configured with binary weights;
train the CNN with the convolution kernel to determine a set of binary weights for the convolution kernel; and
use the set of binary weights for inference of the CNN.

2. The device (300) according to claim 1, configured to train the CNN by:
receiving, at a neuron of the CNN, a backpropagation signal from at least one neuron of a downstream layer of the CNN, wherein the backpropagation signal indicates a tendency of a loss function with respect to a variation of an output of the neuron;
evaluating, at the neuron, a pre-activation function, wherein an input of the pre-activation function comprises an ith binary weight of the neuron and a respective input of the neuron associated with the ith binary weight;
determining a tendency of the pre-activation function with respect to inversion of the ith binary weight; and
determining whether to invert the ith binary weight based on the tendency of the pre-activation function with respect to the inversion of the ith binary weight and the tendency of the loss function with respect to the variation of the output of the neuron.

3. The device (300) according to claim 2, wherein:
the tendency of the loss function with respect to the variation of the output of the neuron indicates whether the variation of the output of the neuron causes the loss function to increase or decrease, and
the tendency of the pre-activation function with respect to the inversion of the ith binary weight indicates whether the inversion of the ith binary weight causes the pre-activation function to increase or decrease.

4. The device (300) according to claim 3, further configured to:
determine to invert the ith binary weight, in response to determining that the inversion of the ith binary weight causes the loss function to decrease; and
determine not to invert the ith binary weight, in response to determining that the inversion of the ith binary weight causes the loss function to increase.

5. The device (300) according to claim 4, further configured to:
determine that the inversion of the ith binary weight causes the loss function to increase if the activation function increases with respect to inversion of the ith binary weight and the loss function increases with respect to the output of the neuron;
determine that the inversion of the ith binary weight causes the loss function to decrease if the activation function increases with respect to inversion of the ith binary weight and the loss function decreases with respect to the output of the neuron;
determine that the inversion of the ith binary weight causes the loss function to decrease if the activation function decreases with respect to inversion of the ith binary weight and the loss function increases with respect to the output of the neuron; and
determine that the inversion of the ith binary weight causes the loss function to increase if the activation function decreases with respect to inversion of the ith binary weight and the loss function decreases with respect to the output of the neuron.

6. The device (300) according to claim 2, further configured to:
determine an ith upstream backpropagation signal for at least one upstream neuron of the CNN based on a tendency of the loss function with respect to a variation of an ith input of the neuron.

7. The device (300) according to claim 1, configured to use binary input values as inputs of neurons of the CNN.

8. The device (300) according to claim 1, wherein a convolution operator of the convolution kernel is a binary-valued operator.

9. The device (300) according to claim 1, further configured to:
determine a pre-activation value for a neuron of the CNN using a convolution for the CNN based on the convolution kernel; and
determine an output of the neuron from the pre-activation value as a binary output based on a threshold value.

10. The device (300) according to claim 9, wherein the threshold value is a parameter to be learnt for the training of the CNN.

11. The device (300) according to claim 1, comprising a plurality of configurable base logics, each comprising:
a feeding receptor for providing an input of the neuron;
a configurable bit for implementing the respective binary weight; and
a convolution operator coupled to the feeding receptor and the configurable bit for performing a convolution operation with respect to the input and the respective binary weight.

12. The device (300) according to claim 1, comprising a memory for storing pre-activation values for neurons of the CNN.

13. A method (900) for processing a convolutional neural network, CNN, the method comprising:
configuring (901) the CNN for utilizing a convolution kernel with binary weights;
training (902) the CNN with the convolution kernel to determine a set of binary weights for the convolution kernel; and
using (903) the set of binary weights for inference of the CNN.

14. The method according to claim 13, wherein the training of the CNN comprises:
receiving, at a neuron of the CNN, a backpropagation signal from at least one neuron of a downstream layer of the CNN, wherein the backpropagation signal indicates a tendency of a loss function with respect to a variation of an output of the neuron;
evaluating, at the neuron, a pre-activation function, wherein an input of the pre-activation function comprises an ith binary weight of the neuron and a respective input of the neuron associated with the ith binary weight;
determining a tendency of the pre-activation function with respect to inversion of the ith binary weight; and
determining whether to invert the ith binary weight based on the tendency of the pre-activation function with respect to the inversion of the ith binary weight and the tendency of the loss function with respect to the variation of the output of the neuron.

15. The method according to claim 14, wherein:
the tendency of the loss function with respect to the variation of the output of the neuron indicates whether the variation of the output of the neuron causes the loss function to increase or decrease, and
the tendency of the pre-activation function with respect to the inversion of the ith binary weight indicates whether the inversion of the ith binary weight causes the pre-activation function to increase or decrease.

16. The method according to claim 15, further comprising:
determining to invert the ith binary weight, in response to determining that the inversion of the ith binary weight causes the loss function to decrease; and
determining not to invert the ith binary weight, in response to determining that the inversion of the ith binary weight causes the loss function to increase.

17. The method according to claim 16, further comprising:
determining that the inversion of the ith binary weight causes the loss function to increase if the activation function increases with respect to inversion of the ith binary weight and the loss function increases with respect to the output of the neuron;
determining that the inversion of the ith binary weight causes the loss function to decrease if the activation function increases with respect to inversion of the ith binary weight and the loss function decreases with respect to the output of the neuron;
determining that the inversion of the ith binary weight causes the loss function to decrease if the activation function decreases with respect to inversion of the ith binary weight and the loss function increases with respect to the output of the neuron; and
determining that the inversion of the ith binary weight causes the loss function to increase if the activation function decreases with respect to inversion of the ith binary weight and the loss function decreases with respect to the output of the neuron.

18. The method according to claim 14, further comprising:
determining an ith upstream backpropagation signal for at least one upstream neuron of the CNN based on a tendency of the loss function with respect to a variation of an ith input of the neuron.

19. The method according to claim 13, wherein binary input values are used as inputs of neurons of the CNN.

20. A computer program comprising program code configured to cause performance of the method (900) for processing a convolutional neural network, when the computer program is executed on a computer, the method comprising:
configuring (901) the CNN for utilizing a convolution kernel with binary weights;
training (902) the CNN with the convolution kernel to determine a set of binary weights for the convolution kernel; and
using (903) the set of binary weights for inference of the CNN.
